(19) United States
(12) Patent Application Publication
(10) Pub. No.: US 2006/0021384 A1
(43) Pub. Date: Feb. 2, 2006

(54) Coating material for a glass mold, method for coating a glass mold as well as a coated glass mold

(76) Inventor: Manfred Schramm, Hummendorf (DE)

Correspondence Address: JORDAN AND HAMBURG LLP, 122 EAST 42ND STREET, SUITE 4000, NEW YORK, NY, 10168, US

(21) Appl. No.: 11/153,727

(22) Filed: Jun. 15, 2005

(30) Foreign Application Priority Data
Jul. 27, 2004 (DE) 102004036343.9-45

(51) Int. Cl. C03B 40/02

(52) U.S. Cl. 65/26; 65/169

(57) ABSTRACT

Coating material for a glass mole, especially for a glass gathering mold, consisting of a) a first coating composition, which is to be applied directly on the glass mold and contains a binder on a silicone resin basis, which cures at a temperature elevated above room temperature, for forming a silicone resin carrier layer, a filler, which can be oxidized during the curing and is to be tied into the silicone resins matrix, the binder and the filler being dissolved or suspended in a solvent, and of b) a second coating composition, which is to be applied on the first coating composition and contains a binder on a silicone resin basis, which can be cured at a temperature elevated above room temperature, for forming a silicone resin support layer and a lubricant, which is to be bonded into the silicone resin carrier layer and has a lubricating effect with respect to the glass composition, which comes into contact with this coating layer, the binder and the lubricant being dissolved or suspended in a solvent.

The invention relates to a coating material for a glass mold, especially a gathering mold.

The production of container glass, such as bottles or preserve jars usually takes place in a two-step process at a glass machine. A drop of molten glass is passed through a gutter system to the individual production stations, where it falls into the so-called gathering mold. This process is called charging. The so-called parison with the already finished mouth of the container is formed there. After transfer to the finishing mold, the bottle is blown into its final shape. Demolding and delivery to the moving pavement of the machine concludes the shaping process. While charging the drop, it is important that the latter is not deformed by friction at the wall of the mold with the formation of charging folds.

In order to ensure this, a glass mold, especially such a gathering mold, usually is treated with a demolding agent, such a treatment generally being referred to as “lubricating”. For this purpose, a lubricating agent composition, consisting of a carrier on a mineral oil basis and a lubricant, such as sulfur or graphite, is painted at regular intervals between 5 and 25 minutes manually into the mold. The lubricant mixture makes good drop charging as well as good demolding without crack formation at the surface of the glass possible. At the same time, the surface of the mold is protected against any corrosive attack by the molten glass.

Such a procedure is already basically disadvantageous, because it is carried out manually and consequently is very expensive. The lubricating cycle is also relatively short-lived. This means that the mold must be lubricated very frequently. The uniformity of the layer applied is also not ensured. Furthermore, the carrier material of the lubricating agent is carbonized because of the high mold temperatures. This is also disadvantageous for the machine operator for work safety reasons.

A further possibility for treating the mold is known from WO 98/57604, which discloses the coating of the mold with a semi-permanent ceramic or ceramic like coating from an aluminum powder as filler and an inorganic binder consisting of an aqueous solution of CrO₃ and H₃PO₄. The latter is constructed from at least two discrete layers, a so-called base coat, which forms the pseudo-ceramic substrate, and a so-called top code, which contains the solid lubricant, for example, in the form of graphite, BN or MoS₂. This base coat forms a hard, structured base layer, to which the top coat adheres well. Overall, the stratified structure has a greater hardness, better adhesion and better abrasion resistance than the one-step coating.

However, it is a problem of this coating that the inorganic binder consists largely of chromium IV oxide and phosphoric acid. The combination of these two chemicals is highly poisonous, harmful to the environment, corrosive, oxidizing and carcinogenic. For this reason, the user is forced to provide adequate safety measures with regard to safety at the workplace as well as environmental protection. Nevertheless, the chromium contamination of the workplace by the worker, entrusted with applying the coating, is increased.

The invention is therefore based on the problem of indicating a coating material which, on the one hand, is not hazardous and, on the other, permits the interference-free introduction of the glass drop as well as the demolding of the parison.

To solve this problem, a coating material is provided for a glass mold, particularly for a gathering mold, consisting of
a) a first coating composition, which is to be applied directly on the glass mold and contains
a binder on a silicone resin basis, which cures at a temperature elevated above room temperature, for forming a silicone resin carrier support layer,
a filler, which can be oxidized during the curing and is to be tied into the silicone resins matrix,
the binder and the filler being dissolved or suspended in a solvent, and of
b) a second coating composition, which is to be applied on the first coating composition and contains
a binder on a silicone resin basis, which can be cured at a temperature elevated above room temperature, for forming a silicone resin carrier layer and
a lubricant, which is to be bonded into the silicone resin carrier layer and has a lubricating effect with respect to the glass composition, which comes into contact with this coating layer,
the binder and the lubricant being dissolved or suspended in a solvent.

The inventive coating material is distinguished by two different coating compositions, which are used to form a base coat or a base coating and a top coat or a top coating. However, a binder, based on a silicone resin, which cures at an elevated temperature and forms a sort of high-temperature lacquer, is used for both coating compositions. Silicone resin is not poisonous and not corrosive and otherwise also not harmful, but nevertheless forms an adequately stable matrix, in which the admixed components of the respective composition can be bonded firmly. The first coating composition forms a very hard base coat layer, in which the oxidized filler, preferably aluminum powder, which oxidizes during the curing into Al₂O₃, forms, a hard, ceramic component, so that the base coat as a whole forms a ceramic or ceramic-like layer.

The second coating composition, which advisably comprises an identical binder based on silicone resin, forms the top coat. Here also, an adequately firm silicone resin matrix layer is formed, in which the lubricant also is bonded adequately firmly. In the region of the interface, both filler materials, that is the filler from the first coating composition and the lubricant from the second coating composition flow somewhat into the respectively opposite layer, so that, on the whole, a secure bond between the layers is formed.

The inventive coating material can be applied without the disadvantages described above and known from the coating of WO 98/57804. During the application, however, some solvent evaporates and, during subsequent heating steps for baking the silicone resin matrix, evaporates completely. This means that the classification according to danger class depends only on the type of solvent used. The use of butyl acetate is preferred as the solvent for the first coating composition. The solvent of the second coating composition may also be butyl acetate or a mixture of butyl acetate and butyl glycol. The latter is of advantage since the admixing of butyl glycol during the curing and, with that, during the curing of the layers of the second coating composition keeps the coating composition liquid or viscous a little longer, since butyl glycol has a somewhat high out boiling point. This enables the lubricant to defuse a little better in to the coating layer below.

As described, aluminum powder, for example, can be used as filler. During the curing, it is oxidized to Al₂O₃ by oxygen from the air as exclusive oxidizing agent. These Al₂O₃ particles are embedded firmly in the silicone resin matrix, so that a ceramic-like basic layer is formed, which is very hard and, as a result of its surface structuring, forms a very good, rough and porous surface with good adhesion for the top coat.

As lubricants, preferably graphite, MoS₂, BN or carbon black is used. It should be pointed out that the list of fillers or lubricants used is not final. Of course, it is conceivable to use other materials, if they are appropriate.

Pursuant to the invention, the first coating composition may contain, based on 100 g:
15-35 g of binder
23.5-53.5 g of filler
the remainder being solvent
   whereas the second coating composition may contain, based on 100 g:
15-35 g of binder
15-35 g of lubricant
the remainder being solvent.

Preferably, the first coating composition contains, based on 100 g:
20-30 g of binder
30-45 g of filler
the remainder being solvent
   whereas the second coating composition may contain, based on 100 g:
20-40 g of binder
20-30 g of lubricant
the remainder being solvent.

In a particularly advantageous embodiment, the first coating composition contains, based on 100 g:
23-28 g of binder
35-43 g of filler
the remainder being solvent
   whereas the second coating composition may contain, based on 100 g:
22-27 g of binder
22-27 g of lubricant
the remainder being solvent.
   In a concrete embodiment of the invention, the coating composition contains, based on 100 g:
26.3 g of binder
40.5 g of filler
the remainder being solvent
   whereas the second coating composition may contain, based on 100 g:
23.8 g of binder
23.8 g of lubricant
the remainder being solvent.

If butyl acetate and butyl glycol are used as solvent for the second coating composition, they should be present in a ratio of 1:1 or with a slight excess of butyl glycol.

In a further development of the inventive concept, the first and/or the second coating composition contains a dissolved or suspended dye. This is of advantage since the application of the layer can be checked visually to ensure that the gathering mold has been covered, over the whole of the surface that is to be covered, with the first coating composition as well as with the second coating composition, the dyes used for the two coating compositions advisably differing in color. The dyes may be of any type. Of course, they should also be completely harmless even during the curing of the mold. The amount added is of the order of a few grams, depending on the degree of dyeing desired. The amount is to be added to the mass compositions per 100 g, which have been given.

Aside from the coating material itself, the invention furthermore relates to a method for coating a glass mold, especially a glass gathering mold, using a coating material of the above-described type, with the following steps:
forming a first layer by applying the first coating composition on the wall of the mold,
forming a second layer by applying the second coating composition on the layer of the first coating composition,
curing the coating compositions for forming the coating by baking the mold.

The first step and/or the second step preferably are formed by applying the first and/or the second coating composition twice, the first coating composition, which forms the base code, preferably being applied two or more times.

The first coating composition and the second coating composition should be applied in a layer thickness of between 40 and 150 μm and especially in a layer thickness of between 50 and 100 μm and preferably in a layer thickness of between 60 and 80 μm, each individual application optionally being coated several times, the application being as homogeneous as possible. Preferably, the composition is applied by spraying, using a lacquer spray gun. The compositions, given above, enable adequately liquid coating compositions to be produced, which can be sprayed. Before they are sprayed, the coating compositions, which are pre-mixed and can be stored at room temperature without problems, must be shaken, in order to distribute any sediment. However, manual application is also possible, since the molds achieve a very long service life coating and careful coating in the dismantled state is possible.

The layers are applied wet-on-wet. This means that the first layer is not cured before the second layer is applied. Instead, it is sufficient if the first layer has dried at the surface before the second layer is applied. At the beginning of the curing process, both layers are still wet, so that the respective materials can readily diffuse between the layers and the solvent or solvents can evaporate off.

The curing itself preferably takes place at a holding temperature of at least 500° C. for at least 60 minutes. The temperature of at least 500° C. is required for adequate oxidation of the filler in the form of the aluminum powder. The holding time for adequate oxidation, as well as for ensuring that all of the solvent is driven off and that the silicone resin matrix is adequately formed, should be at least 60 minutes and preferably at least 90 minutes.

The molds, which are to be baked, should preferably not be brought into the furnace when the latter has already been heated to the holding temperature. The temperature, when the molds are brought into the furnace, should not exceed 200° C. and preferably not 150° C., room temperature being preferred in order to avoid any problems with forming the layers because of the high temperature jump between the mold temperature and the temperature in the interior of the furnace. Preferably, the furnace, in which a mold is baked, is heated from the temperature, at which the mold is brought into the furnace, at a rate of 5° to 10° C./minute to the holding temperature.

The mold surfaces, which are to be coated, must be clean and free of grease, in order to ensure optimum adhesion, especially of the base coat. For this purpose, the molds are cleaned, for example, by sandblasting, especially using a soft grain, before the first coating composition is applied. If a mold is removed from the glass machine because it is to be coated once again, the mold should be cleaned, preferably by treatment with caustic, and/or sand-blasted, especially by using a hard grain, already immediately after removal from the machine,

Finally, the invention relates to a glass mold, especially a gathering mold, with a coating of a coating material of the above-described type, produced by the method described above.

Further advantages, distinguishing features and details of the invention arise out to the examples described in the following, as well as from the drawings, in which

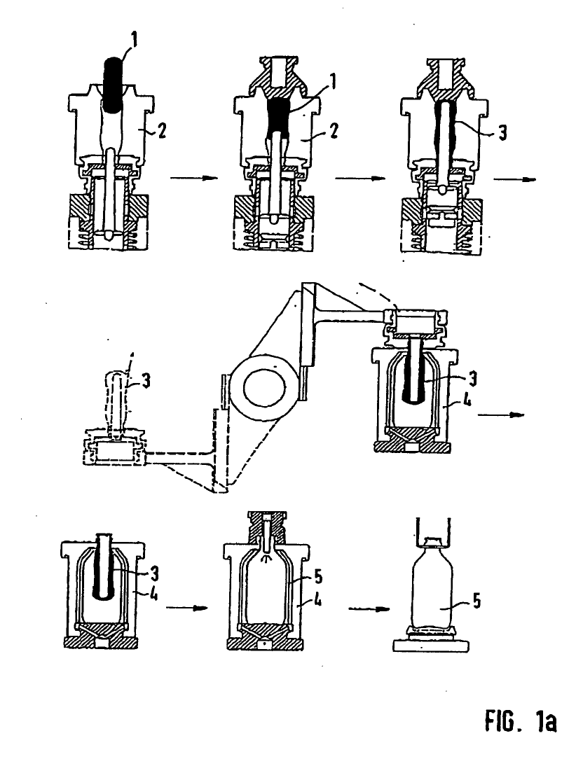

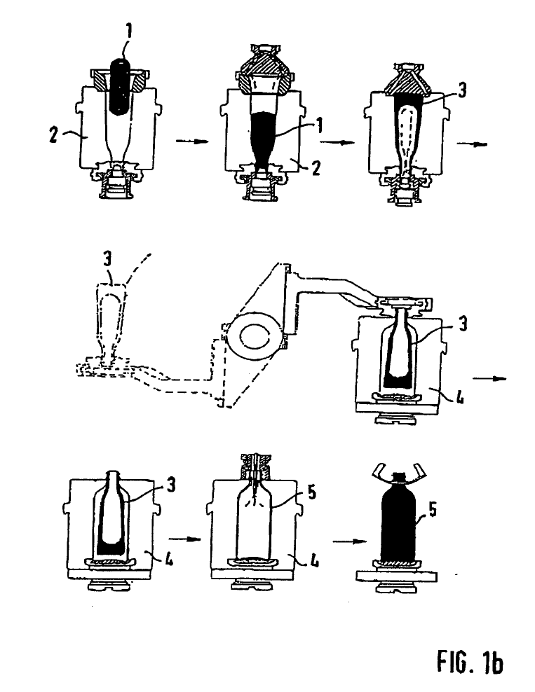

FIGS. 1a, 1b show diagrammatic representations of molding hollow glass objects by the press-blowing method (FIG. 1a) and by the blowing-blowing method (FIG. 1b),

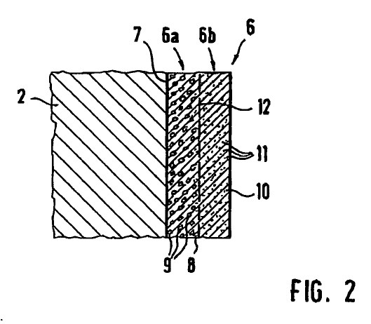

FIG. 2 shows a partial view of a coated gathering mold in section,

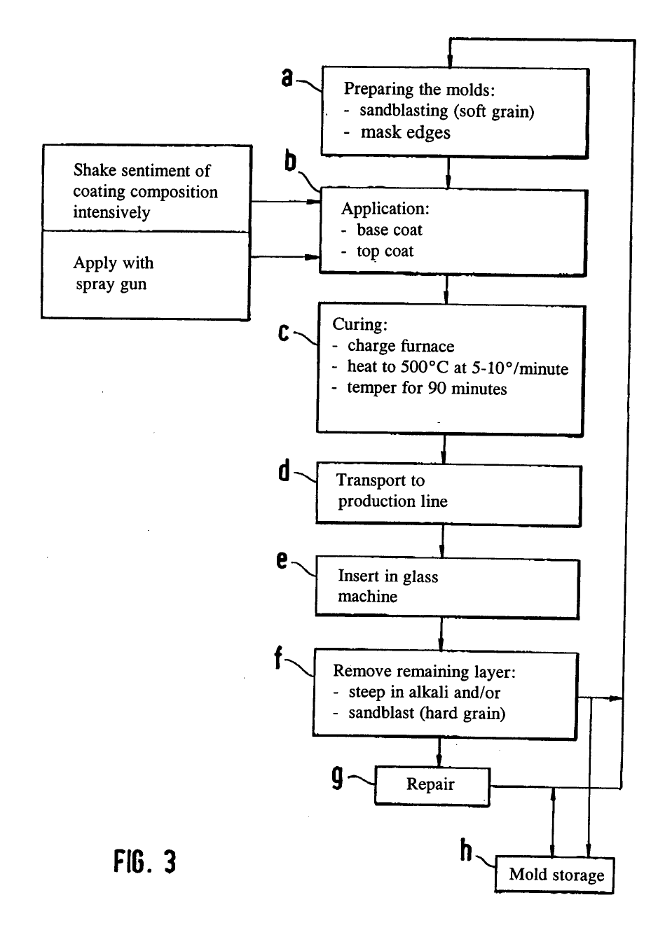

FIG. 3 shows a diagram representing the course of the coating of a gathering mold,

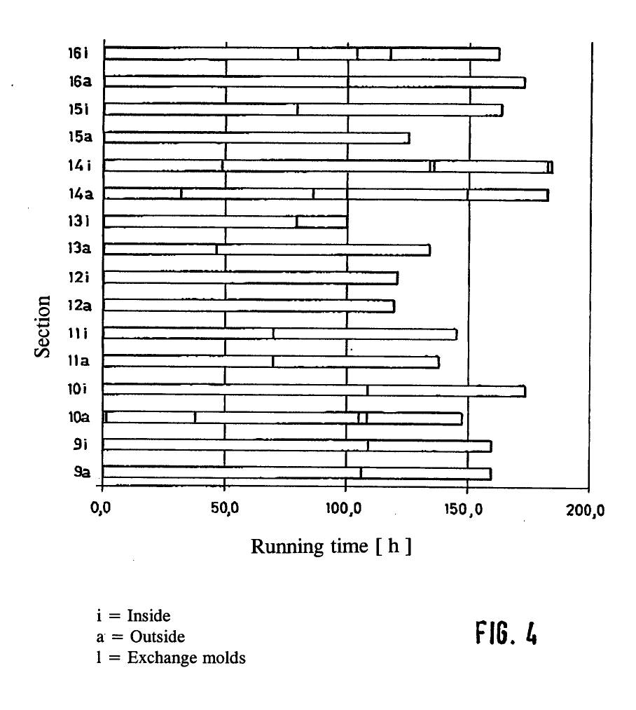

FIG. 4 shows a diagram representing the running time of the gathering mold, coated pursuant to the invention, during the production of a 750 mL Bordeaux bottle

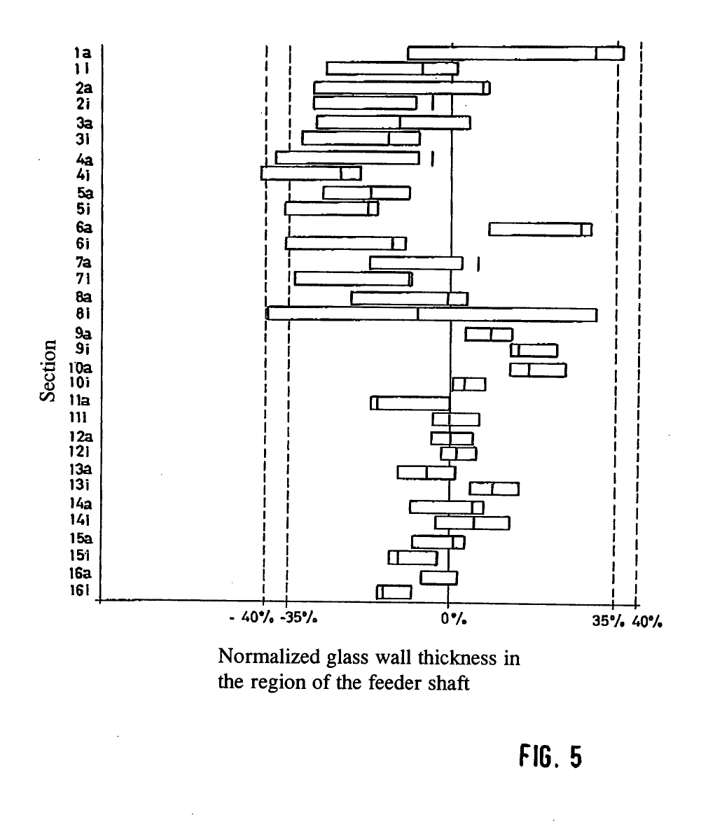

FIG. 5 shows a diagram representing the distribution of wall thicknesses of the bottles produced in the region of the feeder shaft of bottles, produced using the inventive gathering molds and produced using manually lubricated gathering molds,

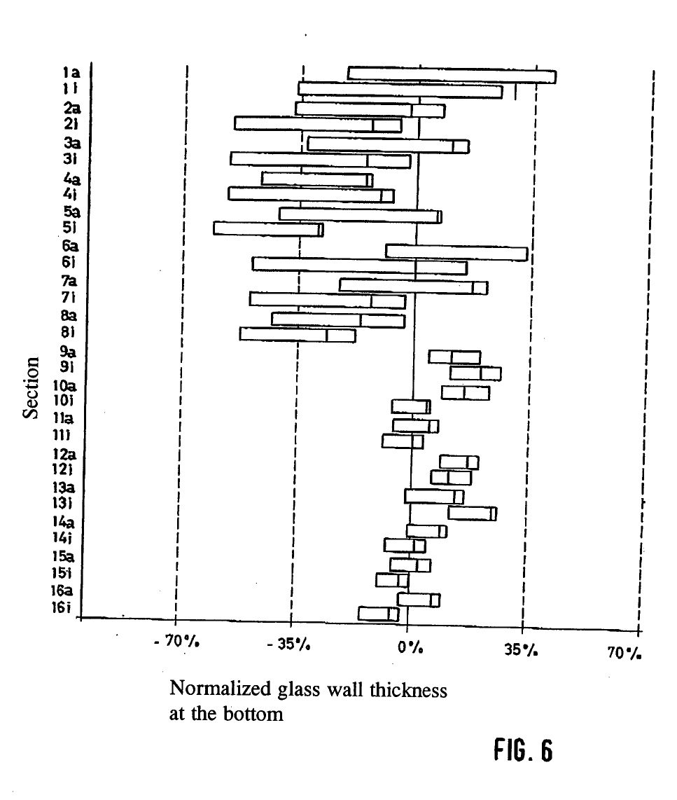

FIG. 6 Shows a diagram corresponding to FIG. 5 for representing the thickness distribution of the bottoms of the bottles and

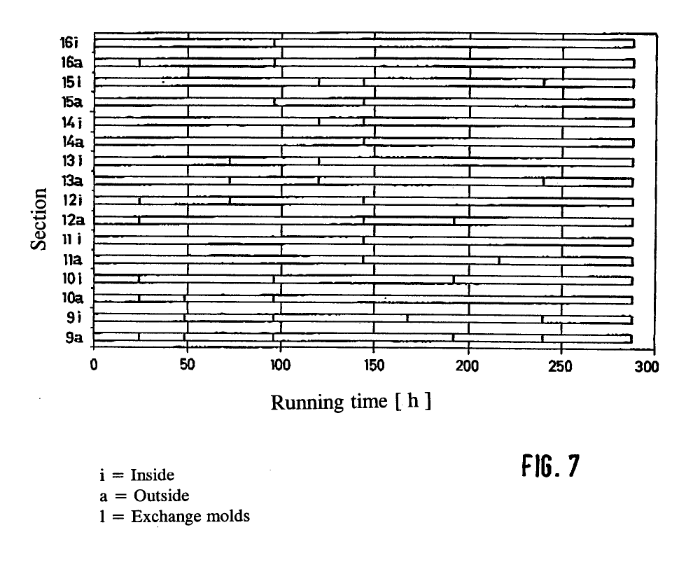

FIG. 7 Shows a diagram for representing the running time of the inventive gathering molds for the production of two and 50 mL Schlegel bottles.

FIG. 1a, in the form of a diagrammatic representation, shows the steps in the production of a hollow bottle by a press-blowing process. For the press-blowing process, a drop 1 of liquid glass falls into a gathering mold 2. The drop of glass 1 was supplied over a conveying gutter, the details of which are not shown, from the glass melt. The gathering mold is integrated in a glass machine. The bringing in of the drop 1 is referred to as charging. Subsequently, the gathering mold is closed at the top, the drop 1 is pressed using a suitable pressing mode and the parison 3 is formed. After the gathering mold is opened, the parison 3 is removed and rotated and brought into the finishing mold 4, where it is blown up into the finished bottle 5 and demolded at the end.

The blowing-blowing process is similar (FIG. 1b). Here also, the drop 1 falls into the gathering mold 2. After the latter is closed, the drop, instead of being pressed, is blown and pre-blown into a parison 3. Subsequently, the parison 3 is removed here also, supplied to the finishing mold 4 where the blowing is finished and the demolded at the end.

Especially the pre-molding step in the gathering mold 2 is as important as any for the absence of defects in the bottle 5 produced. It is necessary to ensure that the drop 1, when it falls into the gathering mold 2, slides in the latter with minimal friction and can slip to the bottom. Consequently, in the case of an inventive gathering mold 2, as shown on an enlarged scale as a partial sectional view in FIG. 2, a coating 6 is provided, which, in the example shown, is already completely cured. It consists of two layers 6a and 6b, each of which was prepared using a special coating composition. Layer 6a forms a so-called the base coat and lies directly on the inner surface 7 of the gathering mold 2, which usually consists of Fe. The coating 6 consists of a silicone resin matrix 8, in which an oxidized filler 9, preferably Al₂O₃, is bonded. The silicone resin matrix 8 is cured, forming a high-temperature lacquer a layer, in which ceramic-like filler particles 9 are bonded. The properties of the layer 6a are such that it can be classified as a ceramic or ceramic-like layer.

Layer 6b is located on layer 6a and also consists of a silicone resin matrix 10. Both silicone resin matrices 8, 10 preferably consist of the same silicone resin. A finely divided lubricant 11, preferably graphite, is now bonded into the silicone resin matrix 10. The glass drop 1 lies directly in contact with the layer 6b, along which it slides, lubricated by the lubricant 11. During the curing, the lubricant 11 diffuses somewhat beyond the interface 12 into the region of the layer 6a, which is close to the interface. It is, however, also possible that some of the oxidized Al₂O₃ filler 9 also diffuses in to the layer 6b.

The preparation of the coating 6 is evident from FIG. 3. In step a, the mold, which is to be coated, first of all his cleaned, preferably by sandblasting using a soft grain. This means that the inner surface 9 of each mold, which is to be coated, is cleaned, so that it is clean and, in particular, free of grease. Preferably, regions of the mold, which are not to be coated, are masked.

In step b, the two coating compositions, using a first coating composition to form the base coat and a second coating composition to form the top coat, are applied, the base coat eventually forming the layer 6a and the top coat eventually forming the layer 6b. The coating compositions, which are adequately liquid, are applied using a conventional commercial lacquering gun. The inner surface of the gathering mold is sprayed uniformly with the first coating composition to form the base coat having a thickness of preferably 60 to 80 μm, two consecutively applied layers of the described thickness, which are disposed on top of one another, advisably being applied. Lacquering defects such as varnish tits or rough places should be avoided.

After the surface of the applied coating layer has commenced to dry slightly, the second coating composition is sprayed on it to form the top coat. This can also be done in two layers.

In step c, the applied layers are cured. The sprayed molds are transferred to a baking furnace, which, when the molds are transferred to it, preferably is at room temperature. In any case, the temperature at this time should not exceed 150° C., in order to avoid too great a temperature jump. After the transfer, the furnace is heated at a rate of 5° to 10°/minute to about 500° C. as holding temperature, at which temperature the molds are baked preferably for 90 minutes. During this time, the solvent, which is used to liquefy the coating composition, evaporates completely, the individual layers form the respective silicone resin matrix 8, 10 and the filler of layer 6a is oxidized. This oxidation is brought about solely by the oxygen in the air, which is present in the furnace atmosphere, so that the oxidized for the particles 9 are formed.

At the end of this step c, the molds are then moved from the furnace and, in step d, transferred to the production line where, in step e, they are placed into the glass machine, which may be a so-called IS machine (IS=independent section).

Because of the inventive coating of the gathering mold, the coating of the latter, contrary to the state of the art with manual lubricating, need not be repeated frequently during use. An inventive gathering mold can be used for several hours, even up to 100 hours and more depending on the application. If it turns out, that a gathering mold must be replaced, which can be ascertained by means of the quality of the bottle produced with it, the gathering mold is removed in step f of the machine and the coating 6, which is still in the mold, is removed by steeping the mold in alkali and/or sandblasting using a hard grain. Any mold repair is carried out in step g, after which the mold can either be placed in storage in step h or supplied directly to step a. Likewise, of course, a mold, which is to be prepared, can be fetched from the mold storage. If a repair is not required, the gathering mold, treated in step f, can also be supplied directly to step a or placed in storage.

FIG. 4 shows a diagram, which clearly indicates the durability of the gathering molds, coated pursuant to the invention. A total of 16 gathering molds is used on a glass machine, which is a 6¼″ double drop IS machine (half tandem) with eight stations. Bordeaux bottles (750 mL), weighing 450 g, were produced by the blowing-blowing method.

The gathering molds used were coated with a material of the following composition:

First Coating Composition for Forming the Layer 6a (Base Coat)

Silicone resin granulate (26.3 g, long-chain phenyl-modified silicone resin) was dissolved in 33.2 g of butyl acetate as solvent. After the silicone resin granulate had dissolved completely, 40.5 g of aluminum powder, with a particle size of less than 20 μm) was added and homogenized using a stirrer.

Second Coating Composition for Forming the Layer 6b (Top Coat)

Silicone resin granulate (23.8 g, long-chain, phenyl-modified silicone resin) was dissolved in 23.8 g of butyl acetate and 28.6 g of butyl glycol. After the silicone resin granulate had dissolved completely, 23.8 g of graphite (fine powder, with a particle size of less than 15 μm) was added and homogenized by shaking.

The coating composition was applied on the gathering mold by spraying. The first coating composition was applied in two superimposed layers with a layer thickness of approximately 60-80 μm and the second layer was applied as a single layer with a thickness of about 60 to 80 μm.

Subsequently, both layers were cured thermally for 90 minutes in a furnace at 500° C. At the end of the curing, the molds were preheated in a pre-heating oven and subsequently inserted in the machine.

As is evident from FIG. 4 by means of the bars indicating the service life of the molds in the respective section, almost all gathering molds used showed a service life of the order of several hours. In some cases, even extreme service lives of more than 100 hours were achieved, before the gathering mold was worn out. The service life of a mold is given by the length of the respective bar section. The vertical lines, which limit a bar section, indicate a mold exchange. By checking the bottles produced, it was established when a mold was worn out, at which time it was exchanged for a new gathering mold, which had been similarly coated pursuant to the invention. FIG. 4 graphically shows the course of the service lives, a maximum of 200 hours having been recorded. The respective bar diagrams only show the service lives of the gathering molds, which were worn out within the maximum service life of 200 hours. Gathering molds, which were inserted before the end of the 200 operating hours but were not worn out by then, are not shown.

In the following, a listing of the running times (given in whole hours) of the individual gathering molds, related to the respective sections, is given in the following Table. As described, almost all the gathering molds used achieved very long service lives. The few gathering molds, which were exchanged already after extremely short service lives of not more than three hours, were damaged usually because of other effects, primarily originating from supplying the drops, and had to be exchanged.

TABLE 1

| | First | Second | Third | Fourth | Fifth |
|---|---|---|---|---|---|
| | Gathering | Gathering | Gathering | Gathering | Gathering |
| Section | Mold | Mold | Mold | Mold | Mold |
| 9a | 106 | 54 | | | |
| 9i | 109 | 51 | | | |
| 10a | 2 | 37 | 67 | 3 | 39 |
| 10i | 109 | 65 | | | |
| 11a | 70 | 68 | | | |
| 11i | 70 | 75 | | | |
| 12a | 120 | | | | |
| 12i | 121 | | | | |
| 13a | 47 | 88 | | | |
| 13i | 80 | 21 | | | |
| 14a | 32 | 54 | 14 | 49 | 33 |
| 14i | 49 | 85 | 2 | 47 | 1 |
| 15a | 126 | | | | |
| 15i | 80 | 83 | | | |
| 16a | 101 | 72 | | | |
| 16i | 80 | 24 | 14 | 43 | |

In FIG. 4, as well as in Table 1, each station had two sections, which are divided in the Figures as well as in the Table into “a” (=outer) and “i” (=inner) Sections 9a-16i are shown. For comparison purposes, gathering molds were used in sections 1a-8i, which had been lubricated manually and cyclically, as in the state of the art, with a lubricant based on a mineral oil. This will still be discussed below.

FIG. 5, in the form of a diagram, shows the gathering mold-related values of the glass thickness of the bottles produced in the region of the feeder shaft, that is, in the region of the widest part of the bottle. The respective thicknesses were determined using an “XPAR” camera system of hot-end testing equipment. This hot-end testing enables the wall thickness to be determined continuously using the heat radiated from the still hot object. The 100 im interval of bottles produced in these same time range is shown. Gathering molds were not exchanged during this time. The gathering molds, used on stations 1-8 (and, with that, in sections 1a-8i) were lubricated, in accordance with the state of the art in this time period, once manually with a lubricant based on mineral oil and graphite using a brush.

Along the abscissa, the nominal value is given at 0% and the respective percentage deviations to the left and the right there of. The shorter the bar, the smaller is the interval deviation over 100 bottles. The representation is normalized.

It is evident that the thickness of the glass wall is significantly more uniform and homogeneous when the inventive gathering mold is used then when the gathering mold, lubricated in accordance with the state of the art, is used. In the latter case, extreme fluctuations were obtained in some cases. This means that, when the inventive gathering molds are used, not only is it possible to operate continuously over a very long time, but products of a high uniformity can also be obtained.

FIG. 6 shows a representation similar to that of FIG. 5. However, in this case, the glass wall thickness in the region of the bottom of the bottle is shown. Here also, in comparison to bottles produced using manually lubricated gathering molds, the wall thickness fluctuations are very slight when inventive molds are used. As described above, the reason for this is that the mold has higher process stability because of the long service life.

Finally, FIG. 7 shows a further diagram, corresponding to that of FIG. 4, from which the running time of the inventive gathering molds may be taken. Here also, a 250 mL Schlegel bottle was produced in a narrow neck press-blowing method with a weight of 155 grams on a 6¼″ double drop IS machine (half tandem) with eight stations. The gathering molds used were coated with materials, which have already been described in relation to the gathering molds of FIG. 4. The operation was designed for 12 production days with a running time totaling 288 hours and was discontinued at the end of the maximum running time, even if the gathering molds were not worn out at the end of the maximum running time. Here also, the length of the bar sections gives the service life of the respective mold and the vertical lines indicate the mold exchanges.

As can be inferred from the following Table 2, very long running times, in some cases extremely long running times (in hours), were obtained here also, with a service life of far beyond 100 hours.

TABLE 2

| | First | Second | Third | Fourth | Fifth |
|---|---|---|---|---|---|
| | Gathering | Gathering | Gathering | Gathering | Gathering |
| Section | Mold | Mold | Mold | Mold | Mold |
| 9a | 24 | 24 | 48 | 48 | 48 |
| 9i | 48 | 48 | 72 | 48 | |
| 10a | 24 | 24 | 48 | | |
| 10i | 24 | 72 | 96 | | |
| 11a | 144 | 72 | 72 | | |
| 11i | 144 | 144 | | | |
| 12a | 24 | 120 | 48 | | |
| 12i | 24 | 48 | 72 | | |
| 13a | 72 | 48 | 120 | | |
| 13i | 72 | 48 | 168 | | |
| 14a | 144 | 144 | | | |
| 14i | 120 | 24 | 144 | | |
| 15a | 96 | 48 | 144 | | |
| 15i | 120 | 24 | 96 | | |
| 16a | 24 | 72 | 192 | | |
| 16i | 96 | 192 | | | |

The examples of FIGS. 4-7 show, on the one hand, that the inventive gathering molds have a very long service life and, on the other, that these service lives were attained even when different hollow glass objects were produced. In comparison to the previous state of the art, which involved manual lubrication over a long period could be realized and, on the other, the frequent and expensive manual lubricating process could be omitted. In comparison to coatings containing the Cr₂O₃ as oxidizing agent, the inventive coating can be produced and processed without problems.

1. Coating material for a glass mole, especially for a glass gathering mold, comprising:
a) a first coating composition, which is to be applied directly on the glass mold and comprises:
a binder on a silicone resin basis, which cures at a temperature elevated above room temperature, for forming a silicone resin carrier layer,
a filler, which can be oxidized during the curing and is to be tied into the silicone resins matrix,
the binder and the filler being dissolved or suspended in a solvent, and
b) a second coating composition, which is to be applied on the first coating composition and comprises:
a binder on a silicone resin basis, which can be cured at a temperature elevated above room temperature, for forming a silicone resin carrier layer, and
a lubricant, which is to be bonded into the silicone resin carrier layer and has a lubricating effect with respect to the glass composition, which comes into contact with this coating layer,
the binder and the lubricant being dissolved or suspended in a solvent.

2. The coating material of claim 1, wherein the filler is aluminum powder.

3. The coating material of claim 1, wherein the lubricant is graphite, MoS₂, BN or carbon black.

4. The coating material of claim 1, wherein the solvent of the first coating composition is butyl acetate.

5. The coating material of claim 1, wherein the solvent of the second coating composition is butyl acetate or a mixture of butyl acetate and butyl glycol.

6. The coating material of claim 1, wherein the first coating composition, based on 100 g, comprises:
15-35 g of binder
23.5-53.5 g of filler
the remainder being solvent
and that the second coating composition, based on 100 g, comprises:
15-35 g of binder
15-35 g of lubricant
the remainder being solvent.

7. The coating material of claim 6, wherein the first coating composition, based on 100 g, comprises
20-30 g of binder
30-45 g of filler
the remainder being solvent
and that the second coating composition, based on 100 g, comprises:
20-30 g of binder
20-30 g of lubricant
the remainder being solvent.

8. The coating material of claim 6, wherein the first coating composition, based on 100 g, comprises:
23-28 g of binder
35-43 g of filler
the remainder being solvent
and that the second coating composition, based on 100 g, comprises:
22-27 g of binder
22-27 g of lubricant
the remainder being solvent.

9. The coating material of claim 6, wherein the first coating composition, based on 100 g, comprises:
26.3 g of binder
40.5 g of filler
the remainder being solvent
and that the second coating composition, based on 100 g, comprising:
23.8 g of binder
23.8 g of lubricant
the remainder being solvent.

10. The coating material of claim 1, wherein the first and/or the second coating composition contains a dissolved or suspended dye.

11. Method for coating a glass mold, especially a glass gathering mold, using the coating material of claim 1, comprising the following steps:
forming a first layer by applying the first coating composition on the wall of the mold,
forming a second layer by applying the second coating composition on the layer of the first coating composition, and
curing the coating compositions for forming the coating by baking the mold.

12. The method of claim 11, wherein the first and/or the second layer is formed by applying the first and/or second coating composition twice.

13. The method of claim 11, wherein the first coating composition and the second coating composition, optionally in the respective application, are applied at a thickness of between 40 and 150 μm, especially of between 50 and 100 μm and particularly of between 60 and 80 μm.

14. The method of claim 11, wherein the coating composition is sprayed on.

15. The method of claim 11, wherein the first layer is surface-dried before the second layer is applied.

16. The method of claim 11, wherein the layers applied are surface-dried before the mold is baked.

17. The method of claim 11, wherein the mold is seated for at least 60 minutes at a holding temperature of at least 500° C.

18. The method of claim 17, wherein the furnace, in which the mode is heated, is heated from the temperature, at which the mold is brought into the furnace, at a rate of 5° to 10° C./minute to the holding temperature.

19. The method of claim 18, wherein the temperature, when the mold is brought into the furnace, does not exceed 200° C. and especially not 150° C.

20. The method of claim 11, wherein the mold is cleaned before the first coating composition is applied.

21. The method of claim 20, wherein the mold is sand blasted, especially using a soft grain.

22. The method of claim 11, wherein the mold is cleaned after removal from the glass machine.

23. The method of claim 22, wherein the mold is steeped in alkali and/or sand blasted, especially using a hard grain.

24. Glass mold, especially a glass gathering mold, produced by the method of claim 11.
